(19) United States
(12) Patent Application Publication
(10) Pub. No.: US 2017/0251631 A1
(43) Pub. Date: Sep. 7, 2017

(54) FEED-SAVING METHOD AND APPARATUS

(71) Applicant: Tabatha S. Webster, Alvord, TX (US)

(72) Inventor: Tabatha S. Webster, Alvord, TX (US)

(21) Appl. No.: 15/603,238

(22) Filed: May 23, 2017

Related U.S. Application Data
(62) Division of application No. 14/534,026, filed on Nov. 5, 2014.
(60) Provisional application No. 61/955,781, filed on Mar. 19, 2014.
(60) Provisional application No. 61/900,976, filed on Nov. 6, 2013.

(51) Int. Cl. A01K 5/01; A01K 1/10

(52) U.S. Cl. CPC A01K 5/01; A01K 1/10

(57) ABSTRACT

In some embodiments, a livestock-feeding apparatus includes an upper frame, a lower frame; and a netting that connects the upper frame and the lower frame together such that the livestock-feeding apparatus has a three-dimensional geometric shape. In some embodiments, a livestock-feeding apparatus includes a clam-shell frame, wherein the clam-shell frame is configured to provide an open position for the apparatus and a closed position for the apparatus, and a netting attached to the clam-shell frame such that the netting is folded upon itself to form a bag that hangs from the clam-shell frame. In some embodiments, a method of feeding livestock includes providing an upper frame and a lower frame, connecting the upper frame to the lower frame with a netting to form a three-dimensional geometric shape, and containing a collection of animal feed within the three-dimensional geometric shape.

### CROSS-REFERENCE TO RELATED APPLICATIONS

This application is a divisional of U.S. patent application Ser. No. 14/534,026 filed on Nov. 5, 2014 by Tabatha S. Webster, titled “FEED-SAVING APPARATUS AND METHOD”, which claims priority benefit, under 35 U.S.C. §119(e), of U.S. Provisional Patent Application No. 61/900,976 filed Nov. 6, 2013 by Tabatha Webster, titled “Hay-Saving Net and Method,” and of U.S. Provisional Patent Application No. 61/955,781 filed Mar. 19, 2014 by Tabatha Webster, titled “Livestock Feed Bag and Method,” each of which is incorporated herein by reference in its entirety.

### FIELD OF THE INVENTION

The invention relates generally to agricultural gear and more particularly to methods and systems for a feed-saving net used to feed livestock.

### BACKGROUND OF THE INVENTION

U.S. Pat. No. 7,325,420 to Thomas Dort et al. (hereinafter, “Dort et al.”) titled “EXPANDABLE KNITTED NET”, issued Feb. 5, 2008, and is incorporated herein by reference in its entirety. Dort et al. describe a knitted net, and more specifically an expandable knitted net. In one form, the net comprises a plurality of fill yarns with an elastomeric performance, which allows the net to expand in the cross-direction. In another form, Dort et al. describe a netting, and more specifically a knitted netting comprising a plurality of chain yarns with dissimilar elongation performance oriented in a first direction, and a plurality of fill yarns oriented in a second direction, wherein the yarns oriented in the second direction secure the yarns oriented in the first direction in position within the netting.

Accordingly, there is a need in the art for improved hay-bale nets for feeding livestock.

### SUMMARY OF THE INVENTION

In some embodiments, the present invention provides a livestock-feeding apparatus that includes an upper frame, a lower frame, and a netting that connects the upper frame and the lower frame together such that the livestock-feeding apparatus has a three-dimensional geometric shape. In some embodiments, the upper frame and the lower frame each have a substantially circular shape such that the livestock-feeding apparatus is configured to fit around a round bale. In some embodiments, the upper frame and the lower frame each have a substantially circular shape such that the livestock-feeding apparatus has a substantially cylindrical shape, wherein the netting extends beyond the upper frame to form a top-side netting that substantially covers a top surface of the three-dimensional geometric shape, wherein the top-side netting is gathered by a first net-collection device that allows the top-side netting to be adjustably opened and closed, and wherein the netting extends beyond the lower frame to form a bottom-side netting that substantially covers a bottom surface of the three-dimensional geometric shape, and wherein the bottom-side netting is gathered by a second net-collection device.

In some embodiments, the present invention provides a livestock-feeding apparatus that includes a clam-shell frame, wherein the clam-shell frame is configured to provide an open position for the bag and a closed position for the apparatus, and a netting attached to the clam-shell frame such that the netting is folded upon itself to form a bag that hangs from the clam-shell frame. In some embodiments, the clam-shell frame includes a first piping structure and a second piping structure, wherein the first piping structure is coupled to the second piping structure via a tension mechanism that allows the first and second piping structures to be selectively placed in the open position and the closed position, wherein the netting includes a single piece of netting having a first end and a second end, and wherein the first end of the netting is attached to the first piping structure and the second end of the netting is attached to the second piping structure.

In some embodiments, the present invention provides a method of feeding livestock that includes providing an upper frame and a lower frame, connecting the upper frame to the lower frame with a netting to form a three-dimensional geometric shape, and containing a collection of animal feed within the three-dimensional geometric shape. In some embodiments, the method further includes forming the upper frame and the lower frame into a circular shape such that the three-dimensional geometric shape is a cylinder, wherein the containing of the collection of animal feed includes placing the three-dimensional shape onto a round bale.

### BRIEF DESCRIPTION OF THE FIGURES

Each of the items shown in the following brief description of the drawings represents some embodiments of the present invention.

FIG. 1A is a perspective view of a round-bale net system 101, according to one embodiment of the present invention.

FIG. 1B is a top view of round-bale net system 101.

FIG. 1C is a side view of round-bale net system 101 having netting 120 in an on-the-square configuration.

FIG. 1D is a side view of a round-bale net system 102 having a netting 125 in an on-the-diamond configuration.

FIG. 1E is a top view of upper piping structure 110, according to one embodiment of the present invention.

FIG. 1F is a top view of an upper piping structure 110.1, according to one embodiment of the present invention.

FIG. 2 is a perspective view of a square-bale net system 201, according to one embodiment of the present invention.

FIG. 3 is a perspective view of a livestock-feeding bag 301, according to one embodiment of the present invention.

FIG. 4A is a perspective side view of a livestock-feeding bag 401, according to one embodiment of the present invention.

FIG. 4B is a perspective top view of livestock-feeding bag 401 in an open position, according to one embodiment of the present invention.

### DETAILED DESCRIPTION OF THE INVENTION

Although the following detailed description contains many specifics for the purpose of illustration, a person of ordinary skill in the art will appreciate that many variations and alterations to the following details are within the scope of the invention. Specific examples are used to illustrate particular embodiments; however, the invention described in the claims is not intended to be limited to only these examples, but rather includes the full scope of the attached claims. Accordingly, the following preferred embodiments of the invention are set forth without any loss of generality to, and without imposing limitations upon the claimed invention. Further, in the following detailed description of the preferred embodiments, reference is made to the accompanying drawings that form a part hereof, and in which are shown by way of illustration specific embodiments in which the invention may be practiced. It is understood that other embodiments may be utilized and structural changes may be made without departing from the scope of the present invention.

The leading digit(s) of reference numbers appearing in the Figures generally corresponds to the Figure number in which that component is first introduced, such that the same reference number is used throughout to refer to an identical component which appears in multiple Figures. Signals and connections may be referred to by the same reference number or label, and the actual meaning will be clear from its use in the context of the description.

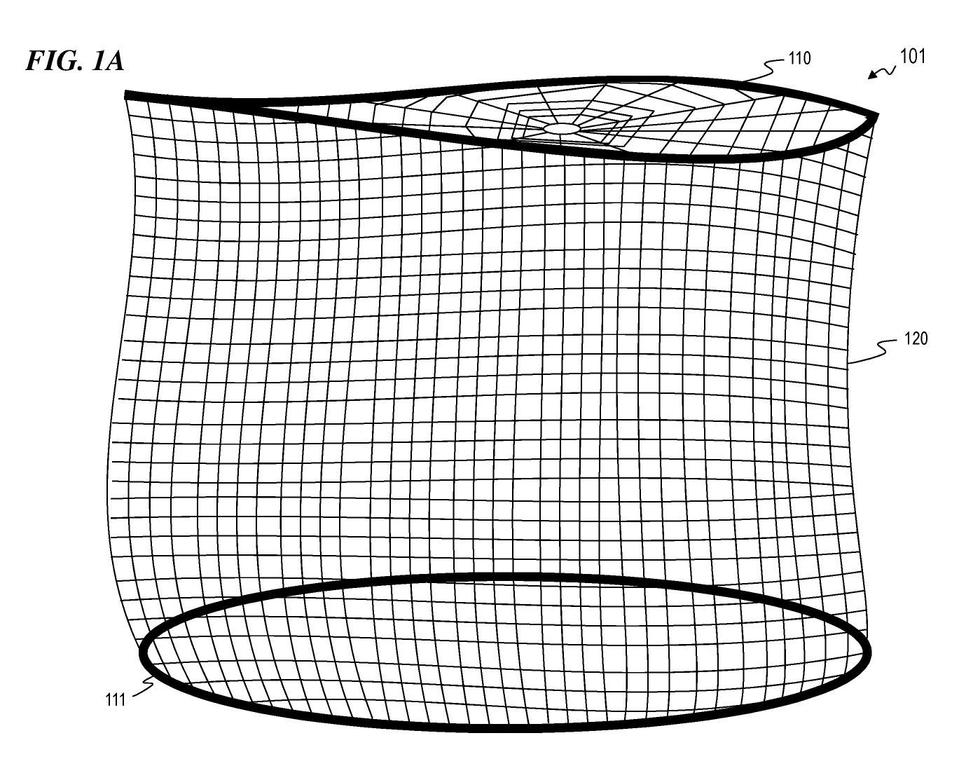

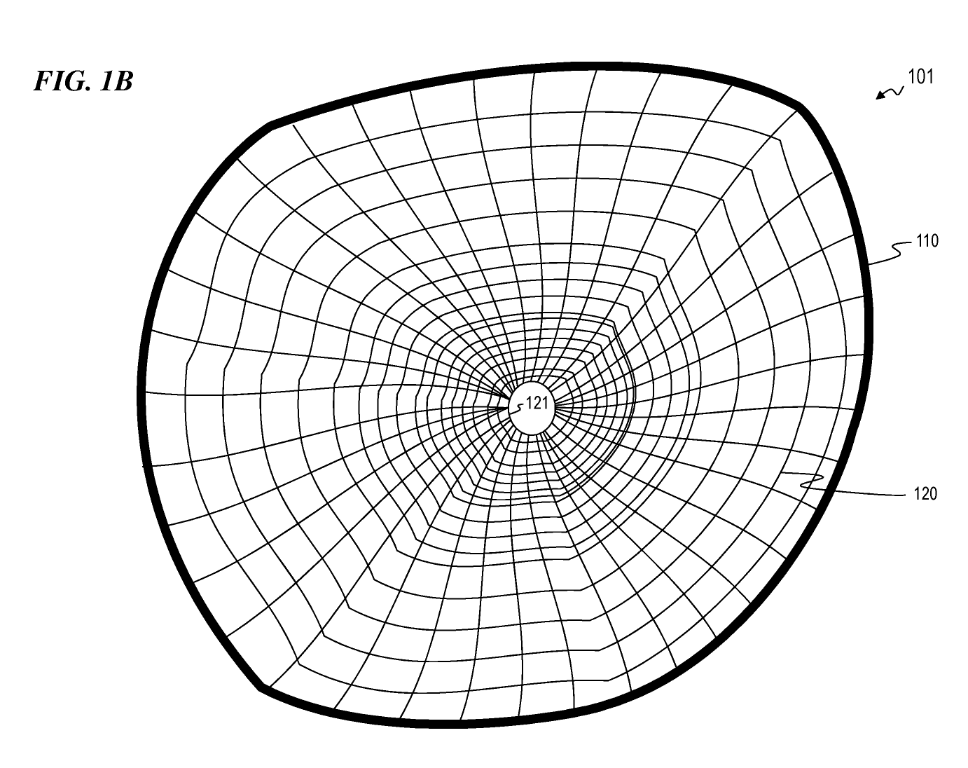

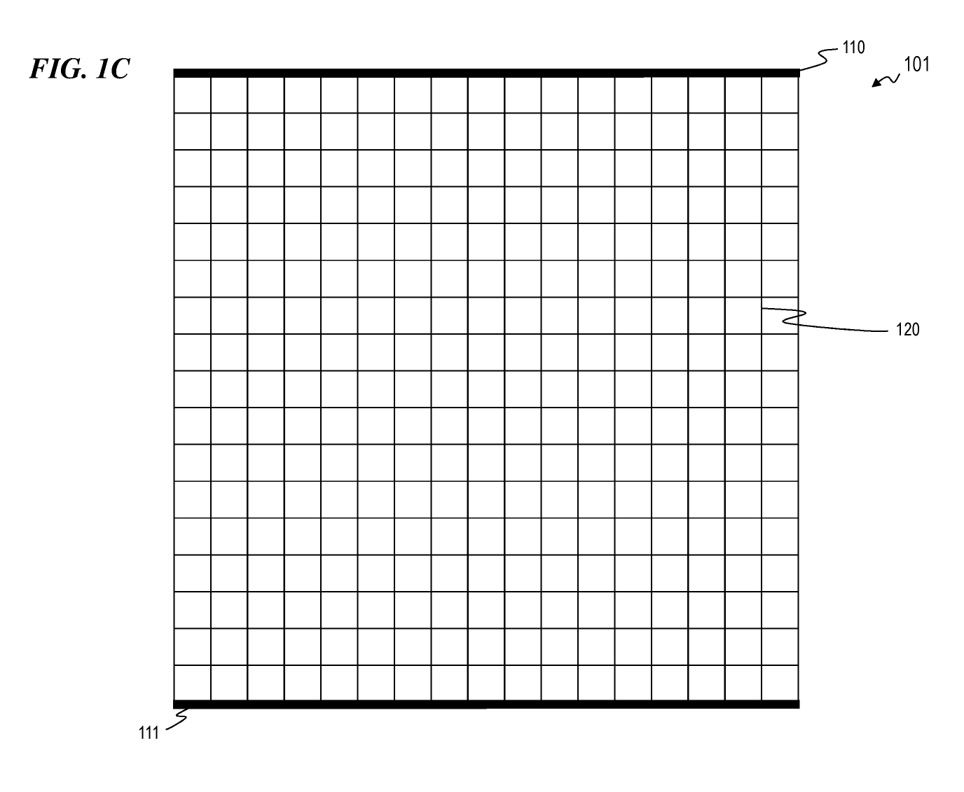

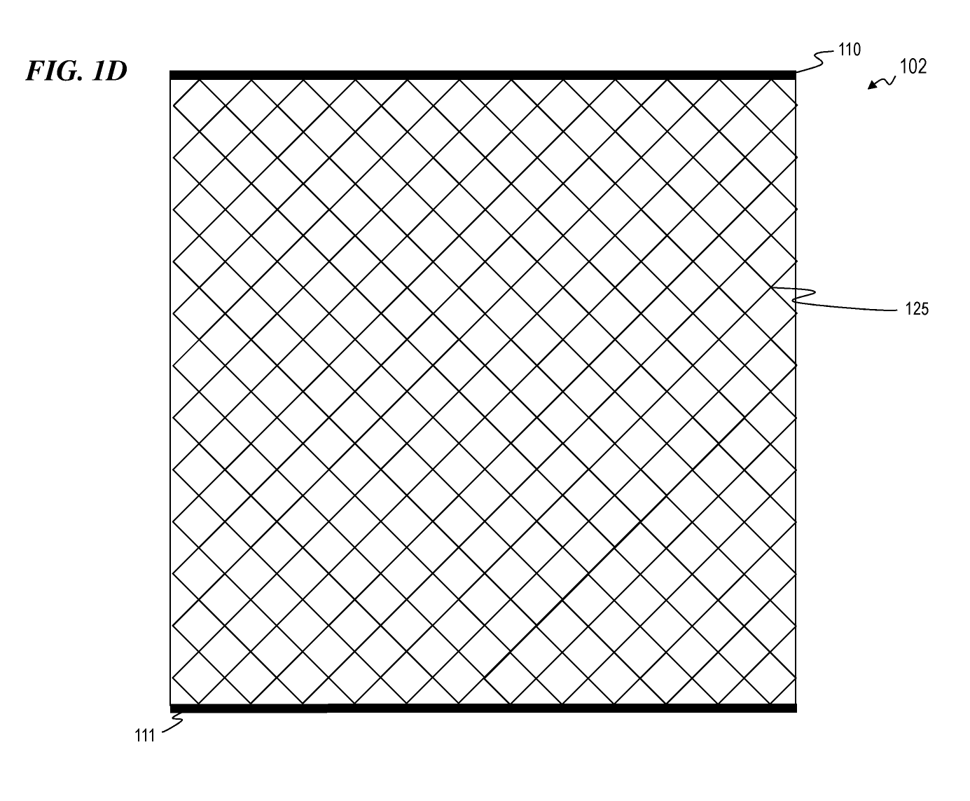

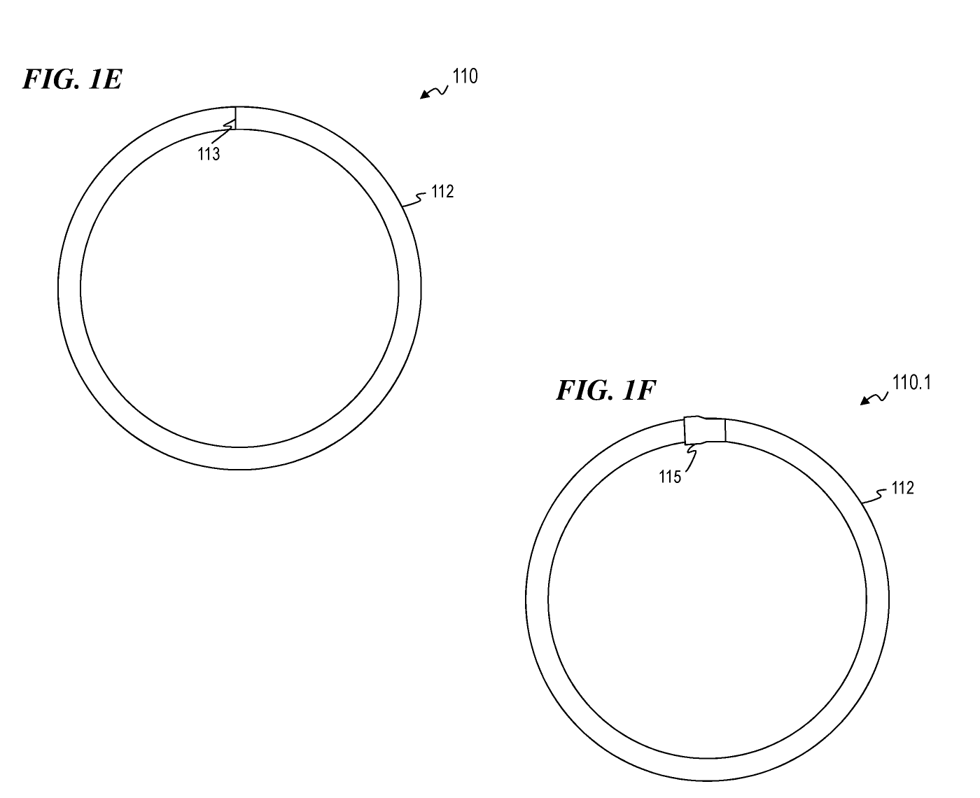

FIG. 1A is a perspective view of a round-bale net system 101, according to one embodiment of the present invention. In some embodiments, net system 101 includes an upper piping structure 110 and a lower piping structure 111 that are coupled to a netting 120. Net system 101 is sometimes referred to herein as the “Haylow Haynets Round Bale Net System”. In some embodiments, round-bale net system 101 forms a cylindrical shape and is designed to accommodate a plurality of different sized round bales. For example, in some embodiments, net system 101 is 80″ (80 inches or approximately 203 centimeters) in diameter and has a height of 4 feet (approximately 1.22 meters), a height of 6 feet (approximately 1.83 meters), or any other suitable height. In other embodiments, net system 101 has any other suitable height size and/or diameter. In some embodiments, as livestock eat the hay bale or other suitable feed contained within system 101, the hay is kept together by netting 120 as upper piping structure 110 collapses down to the lower piping structure 111 and onto the ground. In some embodiments, net system 101 is configured to be used with a livestock feeder such as the “Century” livestock feeders provided by Werner Implement Inc. in Vermillion, Minnesota (www.wernerimplement.com/Feeder/index.html). In some such embodiments, a round bale is placed within the desired “Century” livestock feeder and then net system 101 is placed onto the round bale from above the round bale. In other such embodiments, net system 101 is placed onto the round bale first and then the round bale with net system 101 placed around it is set into the desired “Century” livestock feeder.

In some embodiments, netting 120 is weaved such that a plurality of square-shaped holes is formed (e.g., see FIG. 1A). In some embodiments, netting 120 is weaved such that a plurality of circular holes is formed (not shown). In some embodiments, netting 120 is weaved such that a plurality of holes having any other suitable shape is formed (e.g., in some embodiments, a plurality of holes each having a suitable polygon shape). In some embodiments, netting 120 is weaved to form a plurality of square-shaped holes and netting 120 is connected to the upper piping structure 110 such that the longitudinal axis of upper piping structure 110 runs approximately parallel with at least one side of the squares formed by netting 120 (sometimes referred to herein as an “on-the-square” configuration; see, e.g., FIG. 1C). In other embodiments, netting 120 is weaved to form a plurality of square-shaped holes and netting 120 is connected to upper piping structure 110 such that the longitudinal axis of upper piping structure 110 runs at an approximately 45-degree angle with at least one side of the squares formed by netting 120 (sometimes referred to herein as an “on-the-diamond” configuration; see, e.g., FIG. 1D).

FIG. 1B is a top view of round-bale net system 101. In some embodiments, the top of system 101 is in a closed configuration such that netting 120 is extended beyond upper piping structure 110 and gathered with a net-collection mechanism 121 (e.g., in some embodiments, a metal ring or metal clip, or other suitable mechanism). In some such embodiments, the net-collection mechanism 121 is adjustable such that the top of net system 101 can be opened or closed. In other embodiments, the top of system 101 is open such that netting 120 does not extend beyond upper piping structure 110. In some embodiments, netting 120 does not extend beyond lower piping structure 111 such that the bottom of net system 101 is open for easy application onto a hay bale or other suitable animal feed. In other embodiments, netting 120 at least partially extends beyond the lower piping structure 111 such that the bottom portion of the hay bale is at least partially covered by net system 101.

FIG. 1C is a side view of round-bale net system 101 having netting 120 in an on-the-square configuration. In some embodiments, the on-the-square configuration minimizes the expansion of netting 120 as the feed contained within net system 101 is eaten down. In some embodiments, netting 120 is made from a material that includes a 36-guage black twine. In some embodiments, netting 120 is made from a material that includes a 42-gauge black twine. In some embodiments, netting 120 is made from black twine having any other suitable gauge. In some embodiments, netting 120 is made from a material that includes a wire-mesh netting such as poultry netting. In some embodiments, netting 120 is made of any other suitable material having any other suitable color. In some embodiments, the holes in netting 120 have a width of 1¾″) (1¾-inches or approximately 4.45 centimeters), 1¼ (1¼″-inches or approximately 3.18 centimeters), 1″ (1 inch or approximately 2.54 centimeters), larger than 1¾″ (larger than 1¾-inches or larger than approximately 4.45 centimeters), or any other suitable hole width. In some embodiments, holes larger than 1¾ inches are used for feeding horses in a racetrack setting.

FIG. 1D is a side view of a round-bale net system 102 having a netting 125 in an on-the-diamond configuration. In some embodiments, system 102 is substantially similar to system 101 except that netting 125 is in the on-the-diamond configuration instead of an on-the-square configuration.

FIG. 1E is a top view of upper piping structure 110, according to one embodiment of the present invention. FIGS. 1E and 1F and their corresponding description are described in terms of upper piping structure 110, but, in some embodiments, this description is also applicable to lower piping structure 111. In some embodiments, upper piping structure 110 includes one or more pipe pieces 112 that have a diameter of approximately 1″ (1 inch or approximately 2.54 centimeters). In some embodiments, pipe pieces 112 have any other suitable diameter. In some embodiments, upper piping structure 110 includes pipe pieces 112 having a first diameter, and lower piping structure 111 includes pipe pieces 112 having a second, different, diameter. In some embodiments, each pipe piece 112 is made from a material that includes a polymer (e.g., a polyethylene or the like). In some embodiments, each pipe piece 112 is made from any other suitable material (e.g., a metal, a wood, or the like). In some embodiments, piping structure 110 includes a single pipe piece 112 that is formed into a circular (or approximately circular) shape. In some such embodiments, pipe piece 112 is welded, glued, or otherwise attached to itself at junction 113. In some embodiments, the circular shape formed by upper piping structure 110 has a diameter of 80″ (80 inches or approximately 2.03 meters). In some embodiments, the circular shape formed by upper piping structure 110 has a diameter in a range of approximately 72″ (72 inches or approximately 1.83 meters) to approximately 80″ (80 inches or approximately 2.03 meters).

FIG. 1F is a top view of an upper piping structure 110.1, according to one embodiment of the present invention. In some embodiments, upper piping structure 110.1 includes one or more couplers 115 (sometimes referred to herein as reducers 115) that have a first diameter on a first end and a second, larger, diameter on a second end. In some embodiments, the first end of coupler 115 is affixed (in some embodiments, welded, glued, or the like) to a first end of pipe piece 112 and the second end of coupler 115 is configured to receive a second end of pipe piece 112. In some embodiments, additional attachment mechanisms (e.g., screws, nuts, washers, and the like) are used to further secure the second end of pipe piece 112 within the second end of coupler 115.

In some embodiments, the first diameter of coupler 115 is substantially similar to the diameter of the first end of a pipe piece 112, and the second diameter of coupler 115 is large enough such that the second end of pipe piece 112 (or a separate pipe piece 112) can fit inside of the second end of the coupler 115. For example, in some embodiments, upper piping structure 110.1 includes a single pipe piece 112 that has a 1″ diameter, and the first diameter of coupler 115 is 1″ (1 inch or approximately 2.54 centimeters) and the second diameter of coupler 115 is 1¼ (1.25 inches or approximately 3.18 cm). In some such embodiments, the first end of pipe piece 112 is affixed to the 1″-end of coupler 115, while the second end of pipe piece 112 is coupled into the opposite end of coupler 115 by inserting the second end of pipe piece 112 into the 1¼-end of coupler 115 such that pipe piece 112 and coupler 115 form a circular piping structure. In some embodiments, reducer 115 allows upper piping structure 110.1 to be disconnected from itself and twisted down to a smaller size for shipping. In some embodiments, reducer 115 also provides a mechanism for changing the size of net system 101 such that net system 101 can fit around various-sized bales (for example, in some such embodiments, piping structure 110.1 is enlarged by adding an additional pipe piece 112 that is affixed to an additional coupler 115). In some embodiments, upper piping structure 110 includes a plurality of couplers 115, each having different combinations of diameters, and a plurality of pipe pieces 112, where the couplers 115 and pipe pieces 112 are coupled together to form a circular shape that includes a first pipe piece 112 with a first diameter and a second pipe piece 112 with a second, different, diameter.

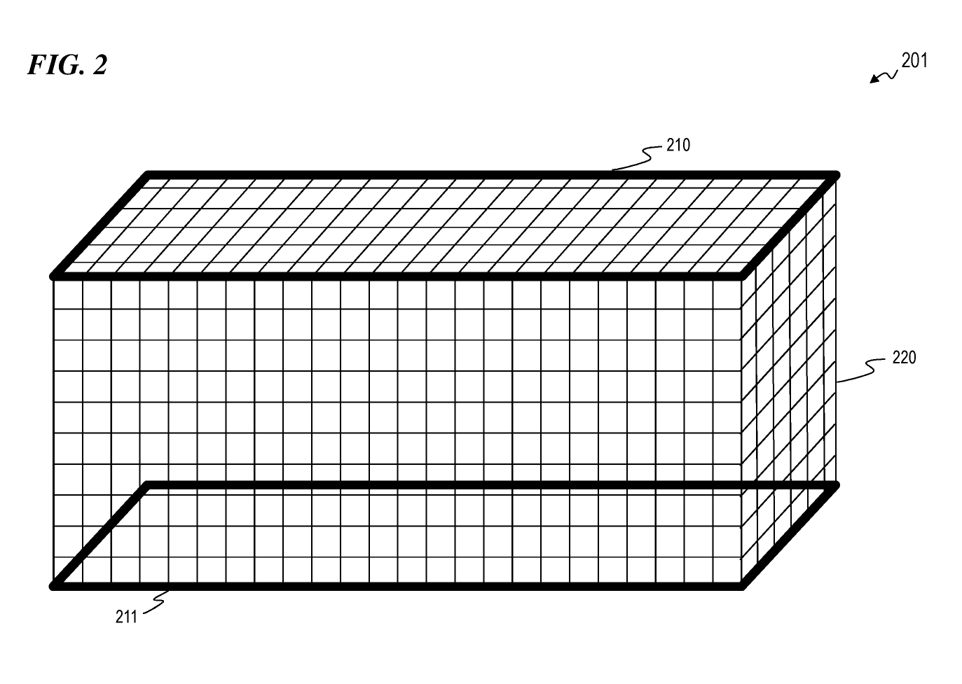

FIG. 2 is a perspective view of a square-bale net system 201, according to one embodiment of the present invention. In some embodiments, net system 201 includes an upper piping structure 210 and a lower piping structure 211 that are coupled to a netting 220. Net system 201 is sometimes referred to herein as the “Haylow Haynets Large Square Bale Net System”. In some embodiments, net system 201 is designed to accommodate a plurality of different sized square bales. In some embodiments, as the livestock eat the hay or other feed contained within system 201, the upper piping structure 210 collapses to the lower piping structure 211. In some embodiments, upper piping structure 210 and/or lower piping structure 211 include pipe pieces that are formed to a rectangular shape. In some such embodiments, the rectangular shape is formed by combining individual pipe pieces and couplers together (such as pipe pieces 112 and couplers 115). In other such embodiments, the rectangular shape is formed by affixing together one or more pipe pieces via welding, gluing, or the like. In some embodiments, upper piping structure 210 and/or lower piping structure 211 are made from a material that includes a polymer (e.g., a polyethylene or the like). In some embodiments, upper piping structure 210 and/or lower piping structure 211 are made from any other suitable material (e.g., a metal, a wood, or the like). In some embodiments, upper piping structure 210 and/or lower piping structure 211 include one or more pipe pieces that have a diameter of approximately 1″ (1 inch or approximately 2.54 centimeters). In some embodiments, the pipe pieces in structures 210 and/or 211 have any other suitable diameter.

In some embodiments, netting 220 is substantially similar to netting 120 except that netting 220 is cut and sewn to fit the rectangular shape formed by upper piping structure 210 and lower piping structure 211 (in some embodiments, the three-dimensional shape formed by net system 201 is a rectangular cuboid). In some such embodiments, the rectangular shape of netting 220 includes a top portion of netting that covers the top portion of the hay bale or other feed contained within net system 201. In other such embodiments, the top portion of netting 220 includes a net-collection mechanism 121 (not shown) that allows the top portion of net system 201 to be adjustably opened and closed. In some embodiments, net system 201 includes a top portion that is not covered by netting 220 (not shown). In some embodiments, the bottom of net system 201 is open for easy application to the hay bale. In other embodiments, netting 220 extends beyond lower piping structure 211 such that the bottom portion of the hay bale contained within net system 201 is at least partially covered by net system 201.

In some embodiments, net system 201 has rectangular dimensions that include a height-by-width-by-length dimension of 5 feet-by-5 feet-by-8 feet (approximately 1.52 meters-by-1.52 meters-by-2.44 meters). In some embodiments, net system 201 includes a height-by-width-by-length dimension of 3 feet-by-4 feet-by-8 feet (approximately 0.91 meters-by-1.22 meters-by-2.44 meters). In some embodiments, net system 201 includes a height-by-width-by-length dimension of 1.5 feet-by-2 feet-by-3 feet (approximately 0.46 meters-by-0.61 meters-by-0.91 meters). In some embodiments, net system 201 has any other suitable height-by-width-by-length dimensions.

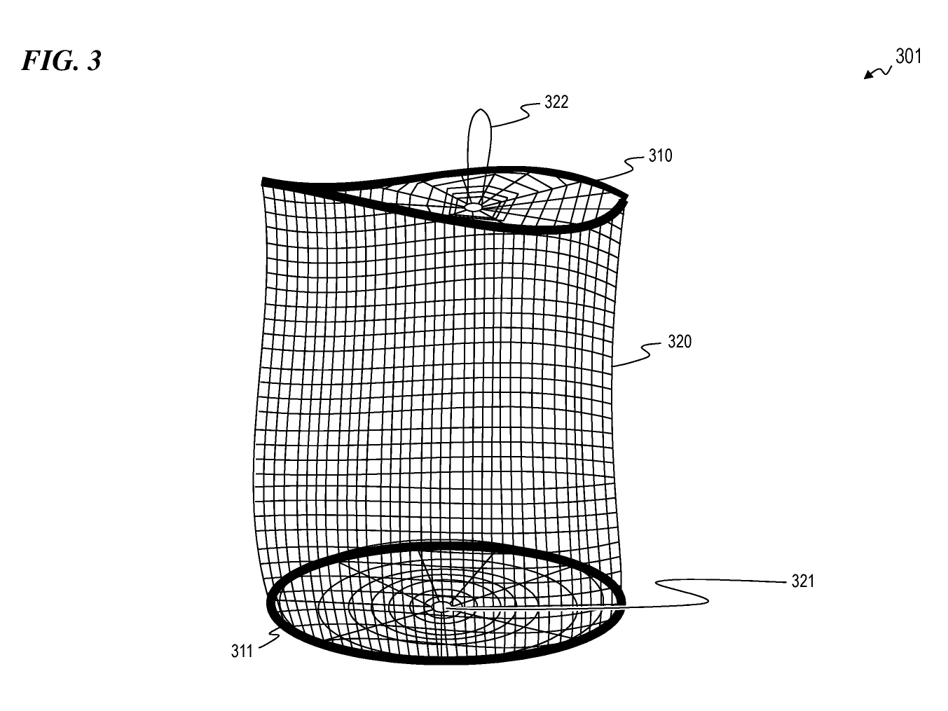

FIG. 3 is a perspective view of a livestock-feeding bag 301, according to one embodiment of the present invention. In some embodiments, bag 301 is referred to as a “Haylow Haynets Small Square Bale Bag” and is configured to hold hay for feeding horses. In other embodiments, bag 301 is configured to hold any other suitable livestock feed (e.g., corn, oats, and the like) and bag 301 is used to feed any suitable livestock (e.g., horses, cows, sheep, and the like). In some embodiments, bag 301 includes an upper pipe frame 310, a lower pipe frame 320, and netting 330. In some embodiments, bag 301 is substantially similar to net system 101 of FIG. 1A except that bag 301 has smaller dimensions designed to hold small square bales and netting 320 of bag 301 extends beyond both upper piping structure 310 and lower piping structure 311 such that both the top and bottom portions of bag 301 are covered by netting 320.

In some embodiments, pipe frames 310 and 311 are made from ¾-inch (approximately 1.91 centimeters) diameter polyethylene pipe. In some embodiments, each respective pipe frame (310 and 311) is formed (e.g., in some embodiments, welded) into a respective 22-inch-diameter (approximately 55.9 centimeters) circle or ring with netting 330 weaved onto the respective pipe frame. In some embodiments, netting 330 is a nylon knotted netting. In some embodiments, the holes of netting 330 are squares with 1¾-inch-long sides (approximately 4.45-centimeters-long sides). In some embodiments, the holes of netting 330 are squares with 1¼-inch-long sides (approximately 3.18-centimeters-long sides). In some embodiments, the holes of netting 330 are squares with 1-inch-long sides (approximately 2.54-centimeters-long sides). In some embodiments, the holes of netting 330 are in any other suitable shape (e.g., circles, octagons, pentagons, and the like) and have any other suitable size. In some embodiments, the hole size is chosen for netting 330 based on how fast it is desired for the livestock to consume the feed contained within bag 301 (e.g., in some embodiments, the smaller the hole size, the slower the feed will be consumed). In some embodiments, netting 330 includes a single “sheet” of netting that is sewn to itself with a single seam of nylon twine.

In some embodiments, the portion of netting 330 that is contained on top of upper pipe frame 310 includes an opening that is adjustably closed with a gathering rope 322. In some such embodiments, rope 322 is a cinching rope. In some embodiments, rope 322 is made from a polymer (e.g., in some embodiments, polyethylene or the like). In some embodiments, the portion of netting 330 located underneath lower pipe frame 311 includes an opening that is configured to be closed with a metal clip 321.

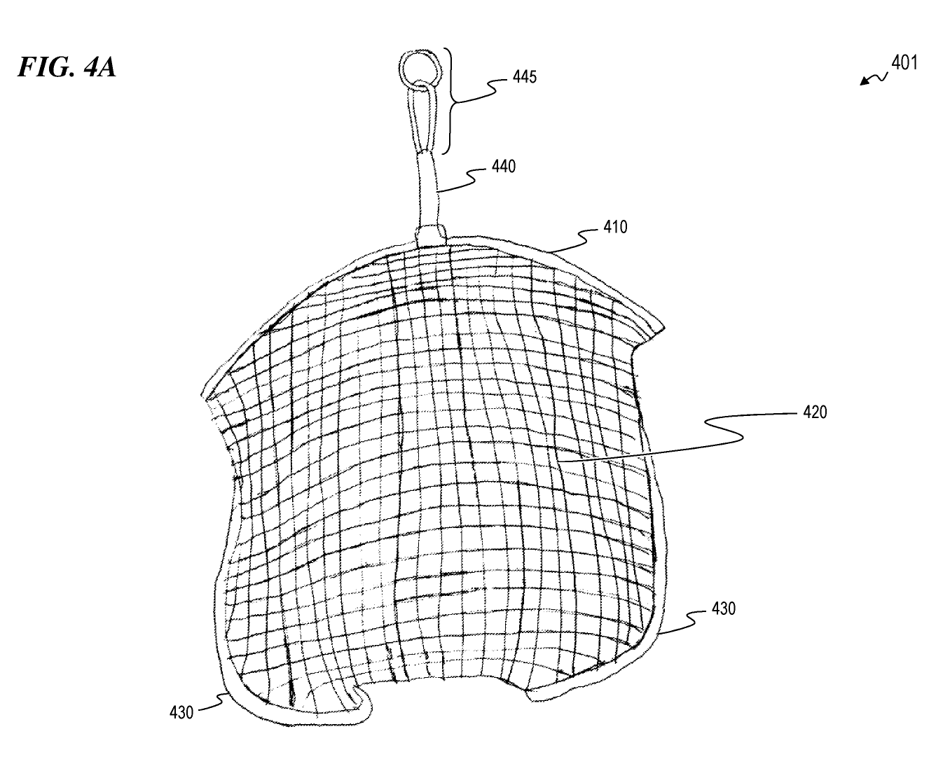

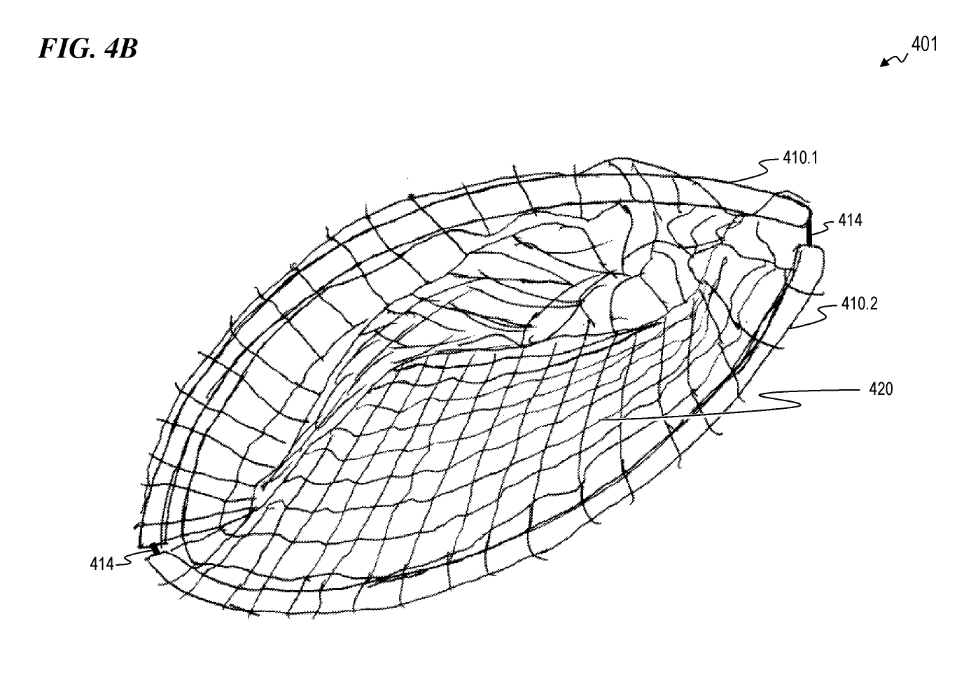

FIG. 4A is a perspective side view of a livestock-feeding bag 401, according to one embodiment of the present invention. In some embodiments, bag 401 is referred to as a “Haylow Haynets Easy Load Hay Bag” and is configured to hold hay for feeding horses by hanging bag 401 up in the air on a hook. In some embodiments, bag 401 is configured to hold any other suitable livestock feed (e.g., corn, oats, and the like). In some embodiments, bag 401 includes a pipe frame 410 and netting 420 that is configured to hang down from pipe frame 410.

FIG. 4B is a perspective top view of livestock-feeding bag 401 in an open position, according to one embodiment of the present invention. In some embodiments, pipe frame 410 is made of two separate pipes (410.1 and 410.2) that are coupled to each other in a clam-shell configuration by a bungee cord 414 (or other suitable tension mechanism). In some such embodiments, bungee cord 414 provides tension to the pipe frame 410 such that pipe frame 410 can be snapped open and shut like a clam shell by placing the two pipes 410.1 and 410.2 adjacent to each other in the closed position and by separating the two pipes 410.1 and 410.2 in the open position. In some embodiments, bungee cord 414 connects pipes 410.1 and 410.2 by passing through each respective pipes central opening. In some embodiments, each end of pipe 410.1 and each end of pipe 410.2 includes an end cap. In some embodiments, bungee cord 414 has a ⅜-inch (approximately 0.95-centimeter) diameter. In some embodiments, bungee cord 414 has any other suitable diameter. In some embodiments, pipe frame 410 is made from a material that includes a polymer (e.g., in some embodiments, a polyethylene). In some embodiments, pipes 410.1 and 410.2 each have ½-inch (approximately 1.27-centimeter) diameter, a ¾-inch (approximately 1.91-centimeter) diameter, or any other suitable diameter (e.g., in some embodiments, a larger diameter pipe is chosen if more durability is needed).

In some embodiments, netting 420 is a single “sheet” of netting that is attached at one end to pipe 410.1 of pipe frame 410 and attached at the other end to the pipe 410.2 of pipe frame 410. In some embodiments, netting 420 is a nylon-knotted netting. In some embodiments, netting 420 is folded substantially in half when attached to pipe frame 410 such that the bottom of bag 401 is formed by the fold of netting 420. In some such embodiments, the sides of bag 401 are formed by sewing the sides of netting 420 together with webbing 430 (in some embodiments, webbing 430 is made of polyethylene, nylon, or any other suitable material). In some embodiments, webbing 430 has a width of 2 inches (approximately 5.08 centimeters). In some embodiments, the holes of netting 420 are square-shaped with 1¾-inch-long sides (approximately 4.45-centimeters-long sides). In some embodiments, the holes of netting 420 are squares with 1¼-inch-long sides (approximately 3.18-centimeter-long sides). In some embodiments, the holes of netting 420 are squares with 1-inch-long sides (approximately 2.54-centimeter-long sides). In some embodiments, the holes of netting 420 are squares with sides greater than 1¾-inches-long (greater than approximately 4.45-centimeters-long) and, in some embodiments, this larger hole size is used for racetrack settings. In some embodiments, the holes of netting 420 are in any other suitable shape (e.g., circles, octagons, pentagons, and the like) and have any other suitable size. In some embodiments, the hole size is chosen for netting 420 based on how fast it is desired for the livestock to consume the feed contained within bag 401 (e.g., in some embodiments, the smaller the hole size, the slower the feed will be consumed).

In some embodiments, bag 401 includes a nylon strap 440 coupled to a metal loop or clip device 445 for hanging bag 401 on a hook. In some embodiments, as shown in FIG. 4A, device 445 includes two linked loops. In other embodiments, device 445 includes a single loop. In some embodiments, nylon strap 440 has a 1-inch (approximately 2.54 centimeters) width. In some embodiments, nylon strap 440 is coupled to pipes 410.1 and 410.2 of pipe frame 410 such that strap 440 assists in holding pipe frame 410 in the closed position. In other embodiments, strap 440 couples to only one of the individual pipes 410.1 or 410.2 such that bag 401 can be opened when it is hanging on a hook.

In some embodiments, the present invention provides a livestock-feeding apparatus that includes an upper frame; a lower frame; and a collapsible side-wall netting that connects the upper frame and the lower frame. In some embodiments, the upper frame includes a top netting. In some embodiments, the livestock-feeding apparatus is configured to fit around a round bale. In some embodiments, the livestock-feeding apparatus is configured to fit around a square bale.

In some embodiments, the present invention provides a livestock-feeding apparatus that includes a ring-shaped upper frame; a ring-shaped lower frame; and a netting coupled to the upper frame and the lower frame, wherein the netting includes an upper portion, a middle portion, and a lower portion, and wherein the upper portion of the netting includes an adjustable opening. In some embodiments, the adjustable opening of the upper portion of the netting includes a rope located around the perimeter of the opening, and wherein the rope is configured to be cinched in order to reduce a size of the adjustable opening. In some embodiments, the lower portion of the netting has an opening that is configured to be closed with a metal clip.

In some embodiments, the present invention provides a livestock-feeding bag that includes a clam-shell frame, wherein the clam-shell frame is configured to provide an open position for the bag and a closed position for the bag; and a netting coupled to the clam-shell frame, wherein the netting is configured to hang from the clam-shell frame. In some embodiments, the clam-shell frame includes a bungee-cord coupled to the clam-shell frame to provide tension for the open and closed positions of the bag. In some embodiments, the livestock-feeding bag further includes a hanging structure coupled to the clam-shell frame, wherein the hanging structure includes a nylon strap coupled to a metal clip.

In some embodiments, the present invention provides a method of feeding livestock that includes providing a livestock-feeding bag that includes: a ring-shaped upper frame, a ring-shaped lower frame, and a netting coupled to the upper frame and the lower frame, wherein the netting includes an upper portion, a middle portion, and a lower portion, wherein the upper portion of the netting includes an adjustable opening, and wherein the adjustable opening includes a rope located around the perimeter of the opening; providing a metal clip; closing the lower portion of the netting with the metal clip; placing the adjustable opening in an open position; inserting livestock feed into the livestock-feeding bag; and closing the adjustable opening by cinching the rope of the upper portion of the netting.

In some embodiments, the present invention provides a livestock-feeding apparatus that includes an upper frame; a lower frame; and a netting that connects the upper frame and the lower frame together such that the livestock-feeding apparatus has a three-dimensional geometric shape. In some embodiments, the netting extends beyond the upper frame to form a top-side netting that substantially covers a top surface of the three-dimensional geometric shape. In some embodiments, the netting extends beyond the upper frame to form a top-side netting that substantially covers a top surface of the three-dimensional shape, and wherein the top-side netting is gathered by a net-collection device. In some embodiments, the net-collection device is configured to adjustably open and close the top-side netting.

In some embodiments of the apparatus, the upper frame and the lower frame each have a substantially circular shape such that the livestock-feeding apparatus is configured to fit around a round bale. In some embodiments, the upper frame and the lower frame each have a substantially rectangular shape such that the livestock-feeding apparatus is configured to fit around a square bale. In some embodiments, the upper frame includes one or more piping structures. In some embodiments, the upper frame includes one or more piping structures made from a material that includes a polyethylene. In some embodiments, the upper frame includes a piping structure that has a first end and a second end, wherein the first end of the piping structure is affixed to the second end of the piping structure such that the upper frame has a circular shape. In some embodiments, the upper frame includes a piping structure and a coupler, wherein a first end of the coupler is affixed to a first end of the piping structure, and wherein a second end of the piping structure is removably inserted into a second end of the coupler such that the upper frame has a circular shape. In some embodiments, the upper frame includes a plurality of piping structures and a plurality of couplers.

In some embodiments of the apparatus, the netting includes a plurality of square-shaped holes, and wherein the netting is attached to the upper frame such that a longitudinal axis of the upper frame runs substantially parallel with at least one side of the square-shaped holes. In some embodiments, the netting includes a plurality of square-shaped holes, and wherein the netting is connected to the upper frame such that a longitudinal axis of the upper frame runs at an angle of approximately 45 degrees relative to at least one side of the square-shaped holes. In some embodiments, the netting is made from a material that includes twine. In some embodiments, the netting extends beyond the upper frame to form a top-side netting that completely covers a top surface of the apparatus.

In some embodiments of the apparatus, the upper frame and the lower frame each have a substantially circular shape such that the livestock-feeding apparatus has a substantially cylindrical shape, wherein the netting extends beyond the upper frame to form a top-side netting that substantially covers a top surface of the three-dimensional geometric shape, wherein the top-side netting is gathered by a first net-collection device that allows the top-side netting to be adjustably opened and closed, and wherein the netting extends beyond the lower frame to form a bottom-side netting that substantially covers a bottom surface of the three-dimensional geometric shape, wherein the bottom-side netting is gathered by a second net-collection device. In some embodiments, the first net-collection device includes a rope configured to cinch together the top-side netting. In some embodiments, second net-collection device includes a metal clip.

In some embodiments, the present invention provides a livestock-feeding apparatus that includes a clam-shell frame, wherein the clam-shell frame is configured to provide an open position for the bag and a closed position for the bag; and a netting attached to the clam-shell frame such that the netting is folded upon itself to form a bag that hangs from the clam-shell frame. In some embodiments, the clam-shell frame includes a first piping structure and a second piping structure, wherein the first piping structure is coupled to the second piping structure via a tension mechanism that allows the first and second piping structures to be selectively placed in the open position and the closed position, wherein the netting includes a single piece of netting having a first end and a second end, wherein the first end of the netting is attached to the first piping structure and the second end of the netting is attached to the second piping structure. In some embodiments, the tension mechanism includes a bungee cord. In some embodiments, the bungee cord runs through a central opening in the first piping structure and the second piping structure.

In some embodiments, the livestock-feeding apparatus further includes a webbing material, wherein the netting is a sewn together with the webbing material to form a first and second side of the bag. In some embodiments, the livestock-feeding apparatus further includes a hanging module, wherein a first end of the hanging module is coupled to the clam-shell frame and a second end of the hanging module is configured to connect to a hook on a wall such that the apparatus is suspended off of a ground surface while the hanging module is connected to the hook. In some embodiments, the hanging module includes a nylon strap coupled to a metal clip.

In some embodiments, the present invention provides a method of feeding livestock that includes providing an upper frame and a lower frame; connecting the upper frame to the lower frame with a netting to form a three-dimensional geometric shape; and containing a collection of animal feed within the three-dimensional geometric shape. In some embodiments, the method further includes forming the upper frame and the lower frame into a circular shape such that the three-dimensional geometric shape is a cylinder, wherein the containing of the collection of animal feed includes placing the three-dimensional shape onto a round bale. In some embodiments, the method further includes forming the upper frame and the lower frame into a rectangular shape such that the three-dimensional geometric shape is a rectangular cuboid, wherein the containing of the collection of animal feed includes placing the three-dimensional shape onto a square bale.

In some embodiments, the method further includes extending the netting beyond the upper frame to form a top-side netting that substantially covers a top surface of the three-dimensional geometric shape. In some embodiments, the method further includes adjustably gathering the top-side netting together. In some embodiments, the forming of the upper frame into a circular shape includes: providing a piping structure having a first end and a second end, and connecting the first end of the piping structure to the second end of the piping structure. In some embodiments, the forming of the upper frame into a circular shape includes: providing a piping structure having a first end and a second end, providing a coupler having a first end and a second end, affixing a first end of the coupler to the first end of the piping structure, and removably inserting the second end of the piping structure into the second end of the coupler.

In some embodiments of the method, the netting includes a plurality of square-shaped holes, wherein the connecting of the upper frame to the lower frame includes attaching the netting to the upper frame such that a longitudinal axis of the upper frame runs substantially parallel with at least one side of the square-shaped holes. In some embodiments, the netting includes a plurality of square-shaped holes, wherein the connecting of the upper frame to the lower frame includes attaching the netting to the upper frame such that a longitudinal axis of the upper frame runs at an angle of approximately 45 degrees relative to at least one side of the square-shaped holes.

In some embodiments, the method further includes extending the netting beyond the upper frame to form a top-side netting that substantially covers a top surface of the three-dimensional geometric shape when the top-side netting is in a closed position; extending the netting beyond the lower frame to form a bottom-side netting that substantially covers a bottom surface of the three-dimensional geometric shape; creating an opening in the top-side netting by placing the top-side netting in an open position; inserting animal feed into the three-dimensional geometric shape through the opening in the top-side netting; and adjustably gathering the top-side netting together to place the top-side netting in the closed position. In some embodiments, the adjustably gathering of the top-side netting together includes cinching a rope operatively coupled to the top-side netting.

In some embodiments, the present invention provides a method of feeding livestock that includes providing a clam-shell frame; adding tension to the clam-shell frame such that the clam-shell frame can be selectively placed in an open position and a closed position; attaching a netting to the clam-shell frame such that the netting is folded upon itself to form a bag that hangs from the clam-shell frame; placing the clam-shell frame in the open position; inserting animal feed into the bag formed by the folded netting; and placing the clam-shell frame in the closed position. In some embodiments, the method further includes hanging the closed clam-shell frame on a hook such that the bag formed by the folded netting is suspended off of a ground surface. In some embodiments, the method further includes forming the sides of the bag by sewing the netting into a webbing material.

In some embodiments, the present invention provides an apparatus that includes means for containing a collection of animal feed during consumption of the animal feed.

It is specifically contemplated that the present invention includes embodiments having combinations and subcombinations of the various embodiments and features that are individually described herein, including the various embodiments described by patent applications and patents incorporated by reference herein (i.e., rather than listing every combinatorial of the elements, this specification includes descriptions of representative embodiments and contemplates embodiments that include some of the features from one embodiment combined with some of the features of another embodiment). Further, some embodiments include fewer than all the components described as part of any one of the embodiments described herein.

It is to be understood that the above description is intended to be illustrative, and not restrictive. Although numerous characteristics and advantages of various embodiments as described herein have been set forth in the foregoing description, together with details of the structure and function of various embodiments, many other embodiments and changes to details will be apparent to those of skill in the art upon reviewing the above description. The scope of the invention should be, therefore, determined with reference to the appended claims, along with the full scope of equivalents to which such claims are entitled. In the appended claims, the terms “including” and “in which” are used as the plain-English equivalents of the respective terms “comprising” and “wherein,” respectively. Moreover, the terms “first,” “second,” and “third,” etc., are used merely as labels, and are not intended to impose numerical requirements on their objects.

What is claimed is:

1. A livestock-feeding apparatus comprising:
a clam-shell frame, wherein the clam-shell frame includes:
piping that provides a feed-entry perimeter, and
a tension mechanism configured to provide tension to the piping such that the feed-entry perimeter can be selectively snapped into an open position that allows feed to pass through the feed-entry perimeter and a closed position that prevents feed from passing through the feed-entry perimeter; and
a netting attached to the clam-shell frame such that the netting is folded upon itself to form a bag that hangs from the clam-shell frame.

2. The livestock-feeding apparatus of claim 1, wherein the piping includes a plurality of pipe sections.

3. The livestock-feeding apparatus of claim 1, wherein the tension mechanism includes a bungee cord.

4. The livestock-feeding apparatus of claim 1, wherein the piping includes a first curved pipe section and a second curved pipe section, and wherein the first curved pipe section is coupled to the second curved pipe section via the tension mechanism.

5. The livestock-feeding apparatus of claim 1, wherein the piping includes a first pipe section and a second pipe section, and wherein the tension mechanism passes through openings in the first pipe section and the second pipe section.

6. The livestock-feeding apparatus of claim 1, wherein the netting includes a single piece of netting having a first end and a second end, wherein the single piece of netting is a nylon-knotted netting, and wherein the piping is threaded through a plurality of openings in the first end of the single piece of netting and a plurality of openings in the second end of the single piece of netting.

7. The livestock-feeding apparatus of claim 1, wherein the piping includes a first curved pipe section and a second curved pipe section, wherein the tension mechanism includes a bungee cord, wherein the bungee cord passes through openings in the first curved pipe section and the second curved pipe section, and wherein the netting includes a single piece of netting.

8. The livestock-feeding apparatus of claim 1, further comprising a webbing material, wherein the netting is a sewn together with the webbing material to form a first edge of the bag and a second opposite edge of the bag.

9. The livestock-feeding apparatus of claim 1, further comprising a hanging device, wherein a first end of the hanging device is coupled to the clam-shell frame and a second end of the hanging device is configured to connect to a hook such that the apparatus can be suspended from the hook, wherein the first end of the hanging device includes a nylon strap, and wherein the second end of the hanging device includes a metal loop.

10. The livestock-feeding apparatus of claim 1, further comprising a hanging device, wherein a first end of the hanging device is coupled to the clam-shell frame and a second end of the hanging device is configured to connect to a hook such that the apparatus can be suspended from the hook, wherein the first end of the hanging device includes a nylon strap, and wherein the nylon strap is coupled to the piping such that the feed-entry perimeter can be snapped into the open position while the apparatus is suspended from the hook.

11. The livestock-feeding apparatus of claim 1, wherein the piping includes a first curved pipe section and a second curved pipe section, wherein the tension mechanism includes a bungee cord, wherein the bungee cord passes through openings in the first pipe section and the second pipe section, and wherein the netting includes a single piece of netting, the livestock-feeding apparatus further comprising:
a webbing material, wherein the netting is a sewn together with the webbing material to form a first edge of the bag and a second opposite edge of the bag; and
a hanging device, wherein a first end of the hanging device is coupled to the clam-shell frame and a second end of the hanging device is configured to connect to a hook such that the apparatus can be suspended from the hook, wherein the first end of the hanging device includes a nylon strap, and wherein the nylon strap is coupled to the piping such that the feed-entry perimeter can be snapped into the open position while the apparatus is suspended from the hook.

12. A method of feeding livestock comprising:
providing a clam-shell frame, wherein the clam-shell frame includes a pair of pipe sections that provide a feed-entry perimeter;
adding tension to the pair of pipe sections such that the feed-entry perimeter can be selectively snapped into an open position that allows feed to pass through the feed-entry perimeter and a closed position that prevents feed from passing through through the feed-entry perimeter; and
attaching a bag to the clam-shell frame.

13. The method of claim 12, wherein the adding of tension to the pair of pipe sections includes:
providing a bungee cord, and
passing the bungee cord through openings in the pair of pipe sections.

14. The method of claim 12, wherein the attaching of the bag includes attaching a single piece of netting to the clam-shell frame such that the single piece of netting is folded upon itself to form the bag, wherein the single piece of netting has a first end and a second end, and wherein the attaching of the single piece of netting includes threading the pair of pipe sections through a plurality of openings in the first end of the single piece of netting and a plurality of openings in the second end of the single piece of netting.

15. The method of claim 12,
wherein the pair of pipe sections include a first curved pipe section and a second curved pipe section;
wherein the adding of tension to the pair of pipe sections includes:
providing a bungee cord, and
passing the bungee cord through openings in the pair of pipe sections;
wherein the attaching of the bag includes attaching a single piece of netting to the clam-shell frame such that the single piece of netting is folded upon itself to form the bag;
wherein the single piece of netting has a first end and a second end; and
wherein the attaching of the single piece of netting includes threading the pair of pipe sections through a plurality of openings in the first end of the single piece of netting and a plurality of openings in the second end of the single piece of netting.

16. The method of claim 12, further comprising:
providing a webbing material; and
sewing the netting together with the webbing material to form a first edge of the bag and a second opposite edge of the bag.

17. The method of claim 12, further comprising:
providing a hanging device having a first end and a second end, wherein the first end of the hanging device includes a nylon strap, and wherein the second end of the hanging device includes a metal loop;
coupling the nylon strap to the clam-shell frame; and
coupling the metal loop to a hook such that the clam-shell frame is suspended from the hook.

18. The method of claim 12, further comprising:
providing a hanging device having a first end and a second end;
coupling the first end of the hanging device to the clam-shell frame; and
coupling the second end of the hanging device to a hook such that the clam-shell frame is suspended from the hook, wherein the coupling of the first end of the hanging device to the clam-shell frame includes connecting the first end of the hanging device to a first pipe section of the pair of pipe sections such that the feed-entry perimeter can be snapped into the open position while the clam-shell frame is suspended from the hook.

19. The method of claim 12, further comprising:
providing a webbing material;
sewing the netting together with the webbing material to form a first edge of the bag and a second opposite edge of the bag;
providing a hanging device having a first end and a second end, wherein the first end of the hanging device includes a nylon strap;
coupling the nylon strap to the clam-shell frame; and
coupling the second end of the hanging device to a hook such that the clam-shell frame is suspended from the hook, wherein the coupling of the nylon strap to the clam-shell frame includes connecting the nylon strap to a first pipe section of the pair of pipe sections such that the feed-entry perimeter can be snapped into the open position while the clam-shell frame is suspended from the hook;
wherein the adding of tension to the pair of pipe sections includes:
providing a bungee cord, and
passing the bungee cord through openings in the pair of pipe sections;
wherein the attaching of the bag includes attaching a single piece of netting to the clam-shell frame such that the single piece of netting is folded upon itself to form the bag.

20. A livestock-feeding apparatus comprising:
a frame, wherein the frame provides a feed-entry perimeter;
means for providing tension to the frame such that the feed-entry perimeter can be selectively snapped into an open position that allows feed to pass through the feed-entry perimeter and a closed position that prevents feed from passing through the feed-entry perimeter; and
means for forming a bag that hangs from the frame.
